(19) United States
(12) Patent Application Publication
(10) Pub. No.: US 2025/0188340 A1
(43) Pub. Date: Jun. 12, 2025

(54) FORMULATION

(71) Applicant: Carbon Chain Technologies Limited, St Sampson, Guernsey (GB)

(72) Inventors: Richard Bryant, Alresford, Hampshire (GB); Patrick Callanan, Midland Park, NJ (US)

(73) Assignee: Carbon Chain Technologies Limited, St Sampson, Guernsey (GB)

(21) Appl. No.: 18/847,190

(22) PCT Filed: Mar. 15, 2023
(86) PCT No.: PCT/EP2023/056667

§ 371 Date: Sep. 13, 2024

Related U.S. Application Data
(60) Provisional application No. 63/320,463, filed on Mar. 16, 2022.

(51) Int. Cl. C09K 8/58; E21B 43/16

(52) U.S. Cl. CPC C09K 8/58; E21B 43/16

(57) ABSTRACT

Provided herein are certain chemical formulations, generally comprising naphthalene, benzyl alcohol, and a third component which may be an aromatic hydrocarbon, methanol or ethanol, or some combination of those; also provided are uses of formulations of these types as viscosity reducing agents, Enhanced Oil Recovery fluids, purifying agents and dehydrogenating agents.

### FIELD

The present disclosure relates to a formulation for use with crude oils; and particularly, although not exclusively, to certain uses of such formulations.

### BACKGROUND

The accelerating green agenda, accentuated by the Covid-19 pandemic, is raising important questions regarding “peak oil”, a flattening in demand growth and the prospect of oil reserves that are costly to commission into production being “orphaned”. However, a comprehensive shift to renewable sources will take many years to complete, during which period there will be a continued demand for fossil fuels. Technologies that can help to mitigate some of the unacceptable environmental characteristics of oil, in terms of both its production and use, have significant value potential.

Given a relentless increase in overall energy demand, heavy crude oil reserves have become an important resource for oil and gas producers and will continue to be so during this transition to renewables. However, production and transportation are often challenging for a variety of reasons.

Although the composition of crude oil varies from location to location, the basic elemental composition shows little variation from one source to another. The typical proportions by weight percentage of the principal components are:

| | |
|---|---|
| Carbon | 83-87% |
| Hydrogen | 10-14% |
| Sulfur | 0.5-6% |
| Oxygen | 0.05-1.5% |
| Nitrogen | 0.1-2% |
| Metals | <0.1% |

Atomic weights (amu, nearest whole number) of typical components are carbon=12, hydrogen=1, sulfur=32, oxygen=16, nitrogen=14, nickel=59, vanadium=51.

All components other than carbon and hydrogen are considered to be impurities or contaminants. The cost and complexity of the refining process can be significantly reduced by processing to remove these impurities before refining. Removal of the impurities gives the product an effectively higher hydrocarbon content. This of course permits better utilisation of the crude oil reserve.

Therefore, there is a need in the art for agents which can perform decontamination with high efficacy and which can thereafter be substantially recovered from the crude oil, avoiding both harm to the environment and the effective substitution of one contaminant for another.

Another avenue for investigation involves the extraction itself: how to maximise or increase the amount of crude oil extracted from a given reserve. Primary recovery (essentially, pumping) and secondary recovery (use of gas or water to displace the crude oil) typically recover only some 25-50% of recoverable oil from a reservoir. Tertiary, or “Enhanced” techniques (Enhanced Oil Recovery or “EOR”) can increase recovery by a further 30-60%. There are three categories of EOR: gas, thermal and chemical. Gas EOR involves the introduction of a miscible gas, typically CO₂, which reduces the oil's viscosity and helps move it to the surface in the way secondary recovery does. Thermal EOR works by heating the oil, either through the use of steam or through combustion, in order to reduce its viscosity. Chemical EOR typically works by freeing trapped oil in the well using, for example, polymer flooding to reduce the surface tensions of the oil and increase its flowability. Thermal EOR is the most widely used technique for the extraction of highly viscous, bituminous oils from porous media. In such media, the crude oil may be held within the pores and hence be harder to extract by traditional methods.

Both Gas and Thermal EOR techniques present challenges: in the case of Gas EOR, due to the lack of CO₂ availability at the required location; in the case of Thermal EOR, due to the requirement for substantial amounts of thermal energy and water to produce steam. Various EOR fluids are known in the art, operating in a variety of ways, including polymers, alkali, and surfactants. However, there remains a need for EOR fluids with low cost, high efficacy in term of increased oil recovery rate, especially from porous media, and reduced or eliminated need for steam.

Many companies in the oil and gas industries have set Sustainability Objectives of “zero emissions” of CO₂ by 2050 as recommended in the Paris Accords, but few have set specific steps they intend to take nor are there any real standards for measuring reductions of CO₂. Improvements in the quality of crude oil (which will reduce environmentally damagingly refinery procedures and enable cleaner burning petroleum products), the simplification of EOR procedures (resulting in less damage to forests, reduced need for water resources) and increase in per well production (which will minimize drilling for new wells) will unquestionably have significant impacts on meeting environmental and social objectives. While it is not practical to measure such effects the inherent values fiscally, socially and environmentally are potentially enormous.

Furthermore, post-extraction, there remains a need for crude oil processing to form useful products. The petrochemicals industry is likely to become a major source of revenue as the use of petroleum fuels declines in the years to come. Accordingly, conversion of crude oil and its fractions to useful chemical entities is an important area of investigation.

It is well understood that within petroleum crude oil various mixtures of hydrocarbons with small amounts of other compounds (sulfur, nitrogen and oxygen, for example) and metals (copper, iron, nickel and vanadium, for example), are present. SARA (Saturates, Aromatics, Resins and Asphaltenes) fractionation is an analysis method that divides crude oil components according to their polarizability and polarity. The Saturate fraction consists of nonpolar material including linear, branched and cyclic saturated hydrocarbons (paraffins). Aromatics which contain one or more aromatic rings are slightly more polarizable. Resins and Asphaltenes have polar constituents. The distinction between the two is often defined as being that Asphaltenes, a solid, are insoluble in an excess of n-heptane (or n-pentane) whereas Resins are miscible with n-heptane (or n-pentane).

Saturates can be further sub-classified into: (1) paraffins or alkanes, which are saturated straight-chain or branched hydrocarbons, without any ring structures; and (2) naphthenes or cycloalkanes, which are saturated hydrocarbons having one or more ring structures with one or more side-chain paraffins. Note that Aromatics, as well as having one or more unsaturated ring structures such as benzene or unsaturated polycyclic ring structures such as naphthalene, may also have one or more side-chain paraffins. Olefins or alkenes, which are unsaturated straight-chain or branched hydrocarbons, do not occur naturally in crude oil, and are products of the refinery cracking process.

In petrochemistry and organic chemistry, cracking is the process whereby complex organic molecules such as kerogens or long-chain hydrocarbons are broken down into simpler molecules such as light hydrocarbons, by the breaking of carbon-carbon bonds in the precursors. The rate of cracking and the end products are strongly dependent on the temperature and may require the presence of catalysts. Cracking is the breakdown of a large alkane into smaller, more useful alkenes. In steam cracking, which is used extensively in petrochemistry applications, hydrocarbons in gas or liquid form are diluted with steam and then briefly heated in a furnace in the absence of oxygen, typically at very high temperatures of 8-900° C. In Fluid Catalytic Cracking (FCC), the feedstock (usually heavy gas oil) is heated to a high temperature and moderate pressure, and then placed in contact with a hot, powdered catalyst, typically zeolites, heated to >700° C. It produces a high yield of petroleum and Liquid Petroleum Gas (LPG). In hydrocracking, hydrogen is added at high pressure (70-80 atm) and temperature (375-500° C.) in the presence of a catalyst (platinum or alumino silicates). It is a major source of jet fuel, naphtha, diesel fuel and yields LPG. A typical example of the cracking process in a refinery starts with the process of breaking high-boiling, straight long-chain alkane (paraffin) hydrocarbons into smaller straight-chain alkanes as well as branched-chain alkanes, branched alkenes (olefins) and cycloalkanes (naphthenes). The breaking of the large hydrocarbon molecules into smaller molecules is technically referred to as “scisson of the carbon-to-carbon bonds”. Some of the smaller alkanes are then broken and converted into even smaller alkenes and branched alkenes which are valuable for use as petrochemical feedstocks. The cycloalkanes (naphthenes) formed by the initial breaking of the large molecules are further converted to aromatics such as benzene, toluene and xylenes, which boil in the gasoline boiling range and have much higher octane ratings than alkanes. They also have value in developing petrochemical products.

All of the cracking procedures mentioned above involve extremely high heat which is generated from combusting gas or oil by-products from the refinery. Along with the cracking procedures there are many additional processes employed in the refinery to purify the crude oil and petroleum products that are produced and they too require processes requiring high heat. Almost all of these processes requiring high temperatures are performed in the presence of catalysts which are subjected to coking and deterioration from exposure to the heat. Refineries operate continuously, 24/7, and incur substantial costs in maintenance, down-time and replacement of catalysts. Many feedstocks, particularly FCC feedstocks containing metal contaminants such as nickel, vanadium, iron and copper, even in the parts per million range, have detrimental effects on the catalyst activity and performance. Nickel and vanadium are particularly troublesome. It is difficult to avoid feedstocks with high metal content which seriously hampers a refinery's flexibility to process various crude oils or purchased feedstock. To mitigate the effects of the contaminant metals, refineries have taken steps to avoid feedstocks with high metals content and employed expensive procedures to pretreat the feedstock with hydrodesulfurization, metal passivation and demetalization procedures, as well as increasing the rate at which catalysts are replaced.

Aromatic hydrocarbons have the highest solvency power of all solvents, with a chemical structure based upon the aromatic 6-carbon atom benzene ring. Benzene, xylene and toluene are the most widely used aromatics and are known collectively as “BXT”. For example, toluene and xylene are used in the manufacture of high-performance surface coatings, rubbers, lacquers and as building blocks for pharmaceutical compounds. The principal process for producing aromatics such as BXT since the 1950s is catalytic reforming, the first step of which is dehydrogenation.

Alkenes, or olefins, are also unsaturated hydrocarbons; that is to say they include at least one C═C double bond. They can be aliphatic (chains), cyclic (rings-aromatics: see above) or aliphatic cyclic (a mixture of chains and rings). Olefins are used as building block materials for many products, including plastics, detergents and adhesives. Ethylene, one of the simplest aliphatic alkenes (C₂H₄), is the largest volume organic chemical produced globally and a basic building block for the chemistry industry. Steam cracking, a form of dehydrogenation, is the primary industrial process for production of olefins. Dehydrogenation is the chemical reaction that involves the direct removal of hydrogen, usually from an organic molecule (e.g. an alkane). It is the reverse of hydrogenation and a useful way of converting alkanes, which are relatively inert and low-value, to alkenes (olefins), which are reactive and thus more valuable. Hydrogenation is the reverse of dehydrogenation and generally involves catalytic hydroprocessing, a reaction necessary in the upgrading of fossil fuels a basis for petrochemistry. Hydroprocessing covers a range of catalytic processes, including hydro treating and hydro cracking for removal of sulfur, oxygen, nitrogen and metals. In the process, sulfur and nitrogen contaminants in the hydrocarbon chains are replaced by hydrogen.

Accordingly it is understood that improvements in the dehydrogenation process are highly sought after.

The industrial processes used to achieve dehydrogenation, principally catalytic cracking, are highly endothermic (and hence environmentally unattractive), requiring temperatures up to 900° C. Heterogenous powder catalysts are used, typically aluminosilicates (zeolites) or platinum based. These can be reused but, typically, no more than five times before decomposition and dispersal reduce effectiveness. Technologies to offset the high energy input required (e.g., auto-thermal and oxidative alkane dehydrogenation) are under development but remain immature. Finding a low cost, effective and environmentally sustainable way of getting from crude oil to petrochemical precursors/intermediaries is a major focus for the industry.

### SUMMARY

The present inventors have found that the remarkable properties of certain formulations can solve the above-mentioned problems. That is, they have found compositions which can act to help remove impurities from (post-extraction) crude oil, to provide dehydrogenation of hydrocarbons, and to increase oil recovery rate from porous media. Certain compositions can also reduce the viscosity of the crude oil.

These formulations may individually provide one, two, three or all four of these effects. Accordingly in some embodiments there are provided formulations which are multifunctional, permitting the user to have a single problem-solving formulation which is applicable in multiple different use cases and circumstances. Such flexibility of usage is remarkable and entirely unpredictable from the state of the art.

The formulation may be added to the crude oil before or after extraction, as a purifying agent, or before or after extraction, as a dehydrogenating agent, or before/during extraction, effectively, as an EOR fluid, or before or after extraction, as a viscosity reducing agent. The formulation indeed may be added to essentially any hydrocarbon mixture comprising an aromatic hydrocarbon or a long chain (C₆₀₊) alkane to achieve dehydrogenation.

The formulation itself comprises, generally:
(a) from about 5 to about 25 weight percent naphthalene;
(b) from about 75 to about 95 weight percent of a component which is either (b1) aromatic hydrocarbon; or (b2) a mixture of aromatic hydrocarbon and methanol or ethanol; or (b3) methanol or ethanol;
and
(c) from about 0.8 to about 4 weight percent benzyl alcohol.

In some embodiments, ingredient (a) is from about 5 to about 15 weight percent naphthalene, preferably about 7 to about 12 weight percent naphthalene. In some alternative embodiments, ingredients (a) is from about 18 to about 21 weight percent naphthalene. In further embodiments, (a) is from about 10 to about 20 weight percent naphthalene.

In some embodiments, ingredient (b1) is included rather than ingredient (b2) or (b3); that is, (b) is exclusively aromatic hydrocarbon. In some embodiments, ingredient (b2) is included rather than ingredient (b1) or (b3); that is, (b) includes both aromatic hydrocarbon and methanol or ethanol. In some embodiments, ingredient (b3) is included rather than ingredient (b1) or (b2); that is, (b) is exclusively methanol or ethanol. Herein, these embodiments may be referred to as type (b1), type (b2) and type (b3) respectively, for brevity. It will be apparent that the various embodiments and preferences expressed herein for (b2) and (b3) apply to embodiments of type (b2) and (b3), respectively.

In some embodiments, ingredient (b1) is from about 85 to about 95 weight percent aromatic hydrocarbon, preferably about 87 to 92 weight percent aromatic hydrocarbon. In some alternative embodiments, ingredient (b1) is from about 75 to about 80 weight percent aromatic hydrocarbon.

In some embodiments, ingredient (b2) is from about 42.5 to about 47.5 weight percent aromatic hydrocarbon and from about 42.5 to about 47.5 weight percent methanol or ethanol, preferably from about 43.5 to about 46 weight percent aromatic hydrocarbon and from about 43.5 to about 46 weight percent methanol or ethanol. In some alternative embodiments, ingredient (b2) is from about 37.5 weight percent to about 40 weight percent aromatic hydrocarbon and from about 37.5 to about 40 weight percent methanol or ethanol.

In some embodiments, ingredient (b3) is from about 85 to about 95 weight percent methanol or ethanol, preferably about 87 to 92 weight percent methanol or ethanol. In some alternative embodiments, ingredient (b3) is from about 75 to about 80 weight percent methanol or ethanol.

In other words, for ingredient (b), the content of that ingredient may be from 0 wt % to 100 wt % aromatic hydrocarbon, with the balance (100 wt % to 0 wt %) being either methanol or ethanol. In some embodiments (b1), (b) is 100 wt % aromatic hydrocarbon. In some embodiments (b3), (b) is 100 wt % methanol or ethanol. In some embodiments (b2), the content of each of aromatic hydrocarbon and methanol or ethanol is >0 wt %.

In some (b2) embodiments, ingredient (b) is from about 20 wt % to about 80 wt %, preferably about 40 wt % to about 60 wt %, most preferably about 50 wt %, aromatic hydrocarbon and the balance is methanol or ethanol.

In (b), in particular (b2) and (b3), where “methanol or ethanol” is present as defined above, it is preferably methanol that is used rather than ethanol.

In some embodiments, ingredient (c) is from about 0.8 to about 3.5 weight percent benzyl alcohol, preferably from about 0.8 to about 3.2 weight percent benzyl alcohol or 0.8 to 2.0 weight percent benzyl alcohol. In some alternative embodiments, ingredient (c) is from about 2.8 to about 3.5 weight percent benzyl alcohol.

Accordingly, in some preferred embodiments, the formulation itself comprises:
(a) from about 5 to about 15 weight percent naphthalene;
(b1) from about 85 to about 95 weight percent aromatic hydrocarbon;
and
(c) from about 0.8 to about 3.5 weight percent benzyl alcohol.

In some other preferred embodiments, the formulation itself comprises:
(a) from about 18 to about 21 weight percent naphthalene;
(b1) from about 75 to about 80 weight percent aromatic hydrocarbon;
and
(c) from about 2.8 to about 3.5 weight percent benzyl alcohol.

In some other preferred embodiments, the formulation itself comprises:
(a) from about 18 to about 21 weight percent naphthalene;
(b3) from about 75 to about 80 weight percent methanol;
and
(c) from about 2.8 to about 3.5 weight percent benzyl alcohol.

In yet further embodiments, the formulation itself comprises:
(a) from about 18 to about 21 weight percent naphthalene;
(b2) from about 37.5 to about 40 weight percent aromatic hydrocarbon and from about 37.5 to about 40 weight percent methanol or ethanol;
and
(c) from about 2.8 to about 3.5 weight percent benzyl alcohol.

It will be understood that in each of these cases the further preferences and options for (a), (b), (b1), (b2), (b3) and (c) discussed herein can be applied.

Ingredient (b1) or (b2) includes aromatic hydrocarbon. This may be a single type of aromatic hydrocarbon (that is, a single compound), or may be a mixture of two or more different types. Where two or more types are present, it may be referred to as a mixed aromatic hydrocarbon. The aromatic hydrocarbon ingredient will be discussed in more detail below.

The formulations discussed herein have found new uses as EOR fluids and agents for removal of impurities from crude oils.

In a first aspect the present disclosure relates to the use of a formulations described herein in a method of removing impurities from crude oil. The method may comprise blending the formulation with a crude oil; and then removing the asphaltenes fraction from the crude oil. Aspects of the disclosure also relate to such a method: that is, to a method of removing impurities from crude oil comprise blending a formulation described herein with a crude oil; and then removing the asphaltenes fraction from the crude oil.

The formulation may suitably be blended with the crude oil at a low concentration such as 1:100 to 1:2000, for example 1:500 to 1:1000 (parts by volume formulation:crude oil).

The inventors have found that this blending has a rapid, almost immediate effect that a substantial proportion of the impurities in the crude oil move to the asphaltenes fraction from the other fractions (explained in more detail below).

The removal of the asphaltenes fraction can proceed using any known method; many such methods are well known in the art. For example, by blending a light (for example, C₃₋₁₀), straight chain alkane such as n-pentane or n-heptane with the crude oil (while in a well or afterwards; after the blending with the formulation) the asphaltenes will precipitate out of the crude oil. This precipitate can be filtered out of the crude oil and discarded, or set aside for further processing (e.g. to recover metals). The resulting crude oil may be referred to as a deasphalted oil (“DAO”), with a substantially lower level of impurities than would otherwise be present.

Such a precipitation step, to remove the asphaltenes fraction, is generally carried out after the crude oil has been extracted from the well; that is, it is carried out outside the well environment.

In a second aspect the present disclosure relates to the use of a formulation as described herein as a dehydrogenating agent for hydrocarbons. In particular, it relates to the use of a formulation as described herein in a method of dehydrogenation of a hydrocarbon. The method may comprise blending the formulation with a mixture comprising the hydrocarbon. Aspects of the disclosure also relate to such methods: that is, to a method of dehydrogenation of a hydrocarbon comprising blending a formulation described herein with a mixture comprising the hydrocarbon.

This blending brings the formulation into contact with the hydrocarbon, leading to a reaction in which a relatively dehydrogenated product (for example an alkene) is formed from a relatively hydrogenated product (for example an alkane). In other words, when a carbon atom in an organic compound (crude oil) loses a bond to hydrogen and gains a new bond to another carbon atom, the compound is said to have been dehydrogenated. When the hydrogen atom ‘transfers’ to another fraction in the crude oil, it is referred to as hydrogenation.

The hydrocarbon to be dehydrogenated may be a component of a mixture, for example a hydrocarbon mixture for example a crude oil. It may be the case that the formulation is used by blending with the crude oil; the specific ‘target’ hydrocarbon(s) for dehydrogenation do not necessarily need to be identified first.

Where the formulation is blended with a crude oil to induce dehydrogenation of hydrocarbon(s) therein, it may be blended at a low concentration such as 1:100 to 1:2000, for example 1:500 to 1:1000 (parts by volume formulation:crude oil).

In a third aspect, the present disclosure relates to the use of a formulation as described herein as an enhanced oil recovery fluid. In particular, it relates to the use of a formulation as described herein in a method of extracting crude oil from a porous medium, in particular boosting the recovery of crude oil from a porous medium. The method may comprise introducing the formulation down an injection well into the porous medium containing the crude oil; and then extracting crude oil from the porous medium. The introduction of the formulation down the injection well brings it into contact with the oil-infused porous medium. On such contact, the formulation mixes with the oil held in the pores and substantially frees it, allowing it to be driven towards a recovery well, from which the freed oil is then extracted. Aspects of the disclosure also relate to such methods: that is, to a method of extracting crude oil from a porous medium, in particular boosting the recovery of crude oil from a porous medium, comprising introducing the formulation down an injection well into the porous medium containing the crude oil; and then extracting crude oil from the porous medium.

In a fourth aspect, the present disclosure relates to the use of a formulation of type (b2) or (b3) (that is, formulations as described herein where at least some methanol or ethanol is present in place of at least some of the aromatic hydrocarbon) as a viscosity reducer. In particular, the viscosity of a crude oil, or other hydrocarbon based fluid such as a fuel oil, can be reduced by mixing with a formulation of type (b2) or (b3) as described herein. Provided is a method of reducing the viscosity of such a liquid, comprising mixing or blending it with a formulation of type (b2) or (b3) as described herein.

In a fifth aspect, the present disclosure is also directed to formulations of type (b2) and (b3) per se.

The disclosure includes the combination of the aspects and preferred features described except where such a combination is clearly impermissible or expressly avoided.

### BRIEF DESCRIPTION OF THE DRAWINGS

Embodiments and experiments illustrating the principles of the disclosure will now be discussed with reference to the accompanying figures in which:

FIG. 1 shows the content of the SARA fractions in a crude oil with and without the present formulation (see Examples 1 and 2).

FIG. 2 shows the H:C atomic ratio for those SARA fractions.

FIG. 3 the weight percentages of various types of alkanes in that oil.

FIGS. 4A-4B show elemental analysis of the distribution (content) of carbon through those SARA fractions.

FIGS. 5A-5B show elemental analysis of the distribution (content) of hydrogen through those SARA fractions.

FIGS. 6A-6B show elemental analysis of the distribution (content) of nitrogen through those SARA fractions.

FIGS. 7A-7B show elemental analysis of the distribution (content) of oxygen through those SARA fractions.

FIGS. 8A-8B show elemental analysis of the distribution (content) of sulfur through those SARA fractions.

FIGS. 9A-9B show elemental analysis of the distribution of certain metal cations through those SARA fractions.

FIG. 10 shows schematically the testing apparatus used in Example 3.

FIGS. 11A-11C are images of the test samples in Example 3 experiments E1, E2 and E3, after treatment to extract the oil.

FIGS. 12A-12C are images from emulsion characterisation of the produced oils from each of experiments E1, E2 and E3 in Example 3.

FIGS. 13A-13C are images of the sample used in Example 4 before oil extraction, after extraction using toluene, and after extraction using Formulation 2.

### DETAILED DESCRIPTION OF THE INVENTION

Aspects and embodiments of the present disclosure will now be discussed with reference to the accompanying figures. Further aspects and embodiments will be apparent to those skilled in the art. All documents mentioned in this text are incorporated herein by reference.

As explained above, the formulations used in the present disclosure comprise, generally:
(a) from about 5 to about 25 weight percent naphthalene;
(b) from about 75 to about 95 weight percent of a component which is either (b1) aromatic hydrocarbon; or (b2) a mixture of aromatic hydrocarbon and methanol or ethanol; or (b3) methanol or ethanol;
and
(c) from about 0.8 to about 4 weight percent benzyl alcohol.

Naphthalene, methanol, ethanol and benzyl alcohol are well known chemical compounds. Their structures are as follows:

| | |
|---|---|
| Naphthalene | 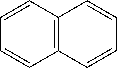 |
| Methanol | 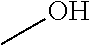 |
| Ethanol | 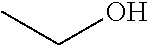 |
| Benzyl alcohol | 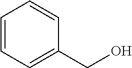 |

The aromatic hydrocarbon component, as mentioned above, may be a single type of aromatic hydrocarbon. Alternatively, it may be a mixture of two or more types of aromatic hydrocarbons.

For example, the aromatic hydrocarbon ingredient may be toluene or xylene, and is suitably toluene. It may be a mixed aromatic hydrocarbon such as those marketed in the Caromax® range (by Haltermann Carless UK Ltd of Cedar Court, Guildford Road, Fetcham, Leatherhead, Surrey KT22 9RX, United Kingdom).

In some embodiments, the aromatic hydrocarbon comprises one or more compounds having the following formula (1):

| | |
|---|---|
| 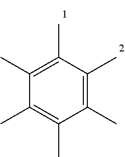 | (1) |

Wherein each of R¹, R², R³, R⁴, R⁵ and R⁶ is independently H, alkyl or aryl.

As used herein, “alkyl” preferably means saturated aliphatic hydrocarbon, which may be either branched-or straight-chained. Preferably, it means C₁₋₆ alkyl. The alkyl group(s), if present, may in some embodiments be independently selected from methyl, ethyl, n-propyl, isopropyl, butyl, sec-butyl, tert-butyl, pentyl and hexyl.

As used herein, “aryl” preferably means a compound comprising an aromatic ring system. Preferably, it means C₆₋₁₀ aryl. The aryl group(s), if present, may in some embodiments be independently selected from phenyl, naphthyl and phenanthryl.

Furthermore, in formula (1), R² and R³ may together form a group:

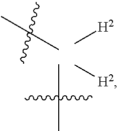

wherein each of R⁷ and R⁸ is independently H, alkyl or aryl, and n is an integer which is 2, 3 or 4.

Where n is 3 or 4, adjacent (vicinal) carbon atoms Cn may be linked by a double bond. Therefore, the compound of formula (1) may form a fused ring system, such as an indane, tetralin, indene or naphthalene.

For example, the compound of formula (1) may have one of the following formulae:

| | |
|---|---|
| 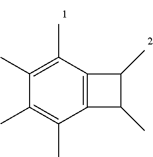 | (1a) |
| 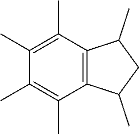 | (1b) |
| 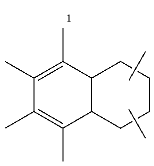 | (1c) |
| 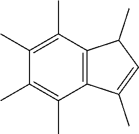 | (1d) |
| 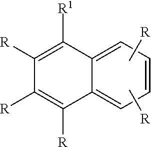 | (1e) |

In some preferred embodiments, each of R¹, R², R³, R⁴, R⁵ and R⁶ is independently selected from H, methyl, ethyl and propyl.

In embodiments where the compound has a formula (1a) to (1e), preferably each of R¹, R⁴, R⁵, R⁶, R⁷ and R⁸ is independently selected from H, methyl, ethyl and propyl.

The aromatic hydrocarbon may comprise one or more compounds having a total of 8 to 10 carbon atoms, preferably 9 to 10 carbon atoms.

The aromatic hydrocarbon may comprise, for example, one or more of the following compounds: 1,2-dimethyl-4-ethyl benzene, 1,2,4,5-tetramethyl benzene, 1,2,3,5-tetramethyl benzene, 1,2,4-trimethyl benzene, 1,2,3-trimethyl benzene, 1-methyl-4-n-propyl benzene, 1,4-dimethyl-2-ethyl benzene, and 1,3-dimethyl-4-ethyl benzene.

An example of a mixed aromatic hydrocarbon which is particularly suitable is CAROMAX® 20, which is commercially available from Carless Refining & Marketing Ltd. of Essex, United Kingdom.

It is believed that CAROMAX® 20 contains the components and in the indicated amounts in the following table.

| Component | Amount (wt %) |
|---|---|
| n-propyl benzene | 0.1 |
| 1-methyl-3-ethyl benzene | 0.3 |
| 1-methyl-4-ethyl benzene | 0.2 |
| 1,3,5-trimethyl benzene | 0.7 |
| 1-methyl-2-ethyl benzene | 0.7 |
| 1,2,4-trimethyl benzene | 17.9 |
| n-decane | 0.2 |
| sec-butyl benzene | 0.2 |
| 1,2,3-trimethyl benzene | 12.4 |
| p-cymene | 0.1 |
| hydrindene | 1.9 |
| 1,3-diethyl benzene | 2.9 |
| 1-methyl-3-n-propyl benzene | 2.4 |
| 1,4-diethyl benzene | 3.2 |
| 1-methyl-4-n-propyl benzene | 6.9 |
| 2-methyl indane | 0.5 |
| 1,2-diethyl benzene | 0.1 |
| 1,4-dimethyl-2-ethyl benzene | 4.8 |
| 1,3-dimethyl-4-ethyl benzene | 4.8 |
| 1,2-dimethyl-4-ethyl benzene | 9.1 |
| 1,3-dimethyl-2-ethyl benzene | 0.5 |
| 1-methyl-4-tert-butyl benzene | 0.1 |
| 1,2-dimethyl-3-ethyl benzene | 1.9 |
| n-undecane | 0.3 |
| 1,2,4,5-tetramethyl benzene | 5.0 |
| 1,2,3,5-tetramethyl benzene | 6.7 |
| trans-1-butyl-2-methyl benzene | 1.1 |
| 1-ethyl-2-n-propyl benzene | 1.2 |
| 5-methyl indane | 0.3 |
| 1-methyl-3-n-butyl benzene | 1.2 |
| 1,2,3,4-tetramethyl benzene | 2.0 |
| n-pentyl benzene | 0.3 |
| tetralin | 0.1 |
| 1,2-diisopropyl benzene | 0.2 |
| 1-methyl-2-n-butyl benzene | 0.6 |
| 1,4-diisopropyl benzene | 0.1 |
| tert-1-butyl-3,5-dimethyl benzene | 0.3 |
| naphthalene | 1.8 |
| dodecane | 0.4 |
| 1,2,3-triethyl benzene | 0.5 |
| 1-methyl indene | 0.4 |
| n-dodecane | 0.3 |
| 1-tert-butyl-4-ethyl benzene | 0.1 |
| 1-methyl-4-n-pentyl benzene | 0.2 |
| 4,7-diethyl-2,3-dihydroindene | 0.1 |
| n-hexyl benzene | 0.05 |
| pentamethyl benzene | 0.2 |
| 2-methyl naphthalene | 0.5 |
| 1-methyl naphthalene | 0.2 |
| di phenyl | 0.5 |

Particular embodiments of the present disclosure may make use of Formulations with the following compositions (all wt %):

### Formulation 1

Naphthalene: 9.5%
Caromax® 20 aromatic hydrocarbon solvent: 89.5%
Benzyl alcohol: 1.0%

### Formulation 2

Naphthalene: 19.1%
Toluene: 77.8%
Benzyl alcohol: 3.1%

### Formulation 3

Naphthalene: 19.1%
Methanol: 77.8%
Benzyl alcohol: 3.1%

### Formulation 4

Naphthalene: 19.1%
Toluene: 38.9%
Methanol: 38.9%
Benzyl alcohol: 3.1%

### Formulation 5

Naphthalene: 20.0%
Toluene: 38.3%
Methanol: 38.3%
Benzyl alcohol: 3.3%

Each of formulations 2, 4 and 5 may equally be prepared using xylene in place of toluene. Such corresponding xylene-containing formulations may be named formulations 2a, 4a and 5a respectively.

The formulations themselves can be prepared by simple mixing of the desired components. After such mixing, it is preferred that the mixture be left for at least 24 hours, and more preferably for at least 72 hours, before being used as described herein. It has also been found that there may be a maximum time for which the mixture should be left before being used. Accordingly, in some methods the mixture is left for at most 144 hours, preferably at most 96 hours, and more preferably at most 75 hours, before being used as described herein.

It is recognised that of the present components of the formulation, some (for example naphthalene) may be solid at room temperature. They may be supplied in a crystalline or powder form. When a component is solid, it may be preferable to melt it by heating before it is mixed with the other components.

The mixing order of the components (a), (b) (which is of (b1) or (b2) or (b3)) and (c) may preferably be (a)+(b), to form a homogenous mixture of (a) with (b), followed by adding (c) to that homogenous mixture.

### Crude Oil Fractions

The present discussion includes some references to crude oil fractions. While this term is well understood in the art, further explanation of some aspects is given here for context.

Crude oil may be analysed in a number of ways, and its many and various components classified in a number of ways. One well known analysis method and classification is the SARA approach.

SARA fractionation identifies the weight percentage of saturated hydrocarbons (Saturates fraction), simple aromatic hydrocarbons (Aromatic fraction), and complicated polyaromatic hydrocarbons (Resins and Asphaltenes fractions) present in crude oils. These fractions are divided according to their polarizability and polarity.

The Saturates fraction of crude oil contains saturated carbon chains (i.e. having no double or triple bonds between carbon atoms). Saturates can be in the form of straight, branched, or cyclic saturated hydrocarbon chains, but the hydrocarbon molecules may also have oxygen, nitrogen, or sulfur in their molecular structure. Molecules including these heteroatoms may be considered impurities.

The compounds in the Aromatics fraction of crude oil may have one or two aromatic rings in their molecular structure, and may also contain oxygen, nitrogen, or sulfur. Such compounds may be seen as impurities.

The Resins and Asphaltenes fractions of crude oil have polyaromatic structures in their molecules and, while the Resins fraction is liquid, the Asphaltenes fraction is solid. They both may have oxygen, nitrogen, sulfur, and metals in their molecular structure, with the concentrations of those impurities being particularly high in the Asphaltenes fraction. The most fundamental distinction between the two is that, while Resins are soluble in light, straight chain alkanes such as n-pentane or n-heptane, Asphaltenes are not.

It is noted that little is known in the literature regarding the exact chemical composition of each SARA fraction. These fractions are typically grouped or classified based on their solubility in different solvents.

### Aspect 1—Removal of Impurities

In a crude oil, various fractions (such as the SARA fractions discussed above) can be defined. Within those fractions there may be impurities, that is, substances which negatively impact the qualities of the crude oil.

For example, Saturates are categorized as saturated hydrocarbons but some impurities are likely to be present in their composition. These “impurities” may comprise any substance other than hydrogen or carbon. In the aromatics fraction, aromatic structures (but not polyaromatic) should be observed; one or two aromatic rings are most common. In the resins fraction, polyaromatic structures with impurities such as nitrogen, sulfur, oxygen, heavy metals, and metal cation components are observed. In the asphaltenes fraction, polyaromatic structures along with similar impurities (nitrogen, sulfur, oxygen, heavy metals) are present but in a greater amount than in the resins fraction.

The present inventors have found that, remarkably, the addition of a formulation of the type described herein leads to such impurities being disproportionately concentrated in the Asphaltenes fraction of the crude oil.

This means that, by removal of the Asphaltenes fraction (by any known procedure, such as using a precipitant such as n-pentane or n-heptane followed by filtration), the crude oil can be purified more effectively than a case in which the presently described formulations are not used.

Accordingly, the present disclosure relates to the use of a formulation as described herein in a method of removing impurities from crude oil. The method may comprise blending the formulation with a crude oil; and then removing the asphaltenes fraction from the crude oil/formulation mix.

In other words, the present disclosure relates to a method of removing impurities from crude oil, comprising blending a formulation as described herein with the crude oil, and then removing the asphaltenes fraction of that blended crude oil (comprising the crude oil and the present formulation).

The formulation may suitably be blended with the crude oil at a low concentration such as 1:100 to 1:2000, for example 1:500 to 1:1000 (parts by volume formulation:crude oil). It has been found that the present formulations are effective even at this low blending concentration.

The present inventors have found that this blending has a rapid, almost immediate effect that a substantial proportion of the impurities in the crude oil move to the asphaltenes fraction from the other fractions as mentioned above. Therefore, there is no particular need for a long time between blending with the crude oil and removal of the asphaltenes fraction. It may however be preferred that the removal occurs within a time period of about 5 minutes to about 2 hours after the blending has been done.

The removal of the asphaltenes fraction can proceed using any known method; many such methods are well known in the art. For example, by blending a light (for example, C₃₋₁₀), straight chain alkane such as n-pentane or n-heptane with the crude oil (while in a well or afterwards; after the blending with the formulation) the asphaltenes will precipitate out of the crude oil. This precipitate can be filtered out of the crude oil and discarded, or set aside for further processing (e.g. to recover metals). The resulting crude oil may be referred to as a deasphalted oil (“DAO”), with a substantially lower level of impurities than would otherwise be present.

It is common in the art for DAO to be made, even without the use of an impurity removal additive. Because of the general properties of the asphaltenes fraction, a DAO is less viscous and hence easier to transport and handle. However, use of the present formulations to concentrate impurities in the asphaltenes fraction means that the resultant DAO is even less viscous (hence cheaper and easier to refine) than any that has gone before.

### Aspect 2—Dehydrogenation

As explained above, dehydrogenation of hydrocarbons is a vital step between crude oil fractions and useful petrochemical products. Existing processes are costly, requiring high temperatures and/or catalytic encouragement.

The present inventors have found that the addition of a formulation of the type described herein to a crude oil can result in dehydrogenation of compounds within that crude oil. The present inventors have also found that addition of a formulation of the type described herein to a mixture comprising an aromatic hydrocarbon or a long chain (C₆₀₊) alkane can result in dehydrogenation of that component.

Remarkably, this dehydrogenation has been found to happen at low additive concentration of the formulation, and without the need for energy input (i.e. the dehydrogenation is not significantly endothermic). This presents a marked improvement over existing industrial processes.

The present inventors believe that such a reaction behaviour may contribute to other advantageous effects noted for the present formulations. Accordingly, the formulations displaying dehydrogenation behaviour can also display other advantageous properties such as impurity removal, EOR fluid potential, or viscosity reduction. Such other properties are described herein.

Accordingly, the present disclosure relates to the use of a formulation as described herein in a method of dehydrogenation of a hydrocarbon. The method may comprise blending the formulation with a mixture comprising the hydrocarbon.

In other words, the present disclosure relates to a method of dehydrogenating a hydrocarbon, comprising blending a formulation as described herein with the hydrocarbon.

The hydrocarbon to be dehydrogenated may be part of a mixture. That mixture may comprise non-hydrocarbon components; it may be a primarily (50 wt % or more, for example 70 wt % or more, 80 wt % or more, 90 wt % or more or 95 wt % or more) hydrocarbon-based mixture. In some embodiments, the mixture is a hydrocarbon mixture; for example, it may be a crude oil.

The formulation may suitably be blended with the hydrocarbon mixture, for example crude oil, at a low concentration. Suitable concentrations are 1:100 to 1:2000, for example 1:500 to 1:1000 (parts by volume formulation:crude oil, for example). It has been found that the present formulations are effective even at this low blending concentration.

### Aspect 3—EOR Fluid

As explained above, an EOR fluid can ideally be used to boost recovery of crude oil from porous media. Such recovery, or extraction, of the crude oil proceeds in a broadly normally fashion, except that an injection well is present for injecting the EOR fluid into the porous medium. Such techniques are well known in the art; various EOR fluids are known and are widely used in the technical field.

For example, there may be a producing well (from which crude oil is to be extracted) and an injection well (into which the EOR fluid is to be injected). The injection well is drilled to a depth sufficient that components injected through it come into direct contact with the oil-holding porous medium. On injection of the EOR fluid, oil is freed from the porous medium and becomes available for extracting through the producing well.

Accordingly, the present disclosure relates to the use of a formulation as described herein in a method of extracting crude oil from a porous medium. The method may comprise introducing the formulation down an injection well into the porous medium containing the crude oil; and then extracting crude oil from the porous medium.

In other words, the present disclosure relates to a method of extracting crude oil from a porous medium, comprising introducing the formulation down an injection well into the porous medium containing the crude oil; and then extracting crude oil from the porous medium.

The inventors have found that the formulations described herein can, remarkably, act as very effective EOR fluids. This can be confirmed by performance of coreflooding experiments, as explained below in the Examples.

### Aspect 4—Viscosity Reduction

Reducing viscosity of a viscous liquid can be advantageous for a wide variety of reasons; in particular improved handling, greater ease of extraction (for example from an oil well), and reduced drag (and hence wear) in pipelines or other processing equipment. In particular, reduction of viscosity at room temperature (or thereabouts), without the need for providing additional heat energy, is advantageous.

For example, a formulation of type (b2) or (b3) can be added to crude oil while it is in the well; this now lower viscosity crude oil can more easily be extracted.

In another example, a formulation of type (b2) or (b3) can be added to a crude oil after it has been extracted from the well; this now lower viscosity crude oil can more easily be pumped for processing and more easily handled for that processing.

Viscosity of an organic liquid (such as, and preferably, a crude oil or DAO) can simply be achieved by mixing the organic liquid with a formulation of type (b2) or (b3).

The amount of the formulation of type (b2) or (b3) to be mixed with the organic liquid may be, for example, at least 1:2000 by volume (that is, for every 2000 litres of organic liquid at least 1 litre of the formulation of type (b2) or (b3) is added).

Preferably, the amount added is at least 1:1000, more preferably 1:500, even more preferably at least 1:250 and most preferably at least 1:100.

Of course, economic factors may mean it is in fact preferable to add less of the formulation to achieve the desired result at lower cost; accordingly in some embodiments it may be preferred that the amount added is from 1:2000 to 1:1000 by volume.

Of course, where the formulation is added to a crude oil in a well, the amount of oil in the well is unknown.

Ideally, the mixture is left for some time after mixing to maximise the viscosity reduction effect. In some embodiments, the mixture is left for at least 24 hours; more preferably at least 48 hours; and most preferably at least 72 hours. It has also been found that there may be a maximum time for which the mixture should be left before being used. Accordingly, in some methods the mixture is left for at most 144 hours, preferably at most 96 hours, and more preferably at most 75 hours, before being used as described herein.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

### EXAMPLES

### Example 1

### Removal of Impurities

A crude oil sample taken from the Fort McMurray area of the Athabasca Region was mixed (blended) with a formulation as described above as Formulation 2.

The formulation was prepared by mixing the components of the formulation followed by leaving the mixture to stand for 72 hours. The formulation was blended with the crude oil sample at a ratio of 1:500.

Various comparisons of the chemical composition of the crude oil sample with and without the additive were performed.

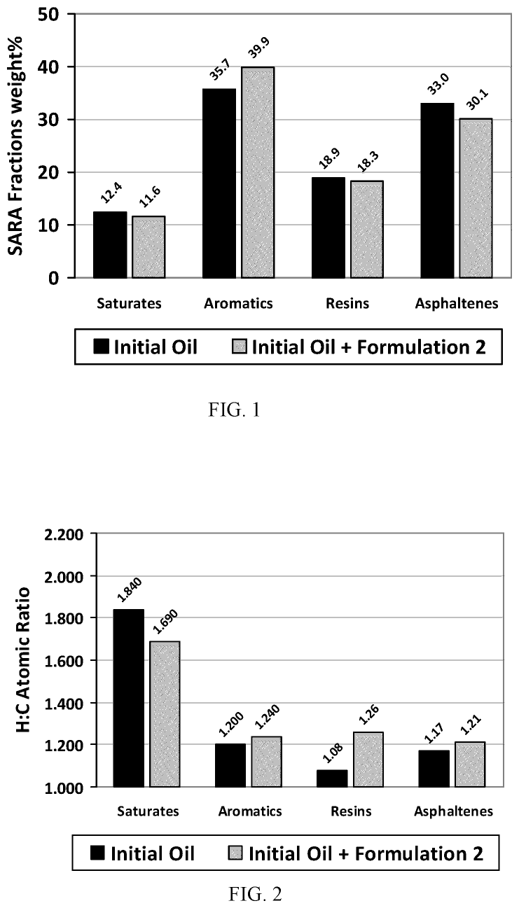

FIG. 1 shows the content of the SARA fractions in the crude oil with and without the formulation. It can be seen that the weight percentage of the heavier Resins and Asphaltenes fractions were reduced and the weight percentage of the lighter Aromatics fraction was increased.

FIG. 2 shows the H:C atomic ratio for the SARA fractions. In petroleum processing, it is important to consider hydrocarbon saturation. A high H:C atomic ratio is desirable. The H:C ratio provides an idea of the chemical stability and processing characteristics of the crude oil.

As shown in FIG. 2, the H:C atomic ratio in the Saturates fraction decreased; that is to say, the Saturates fraction of the crude oil apparently became less hydrogenated, while hydrogen saturation decreased with the addition of the formulation. Following a mass balance approach, it can be concluded that hydrogen atoms in the Saturates fraction travelled to or became part of other fractions: this can be supported by the increase in H:C atomic ratio observed in the remaining fractions.

In other words, the addition of the formulation to the oil sample triggered the transfer of hydrogen atoms to the non-Saturate oil fractions. As a result, the heavier fractions became more saturated: their hydrogenation increased.

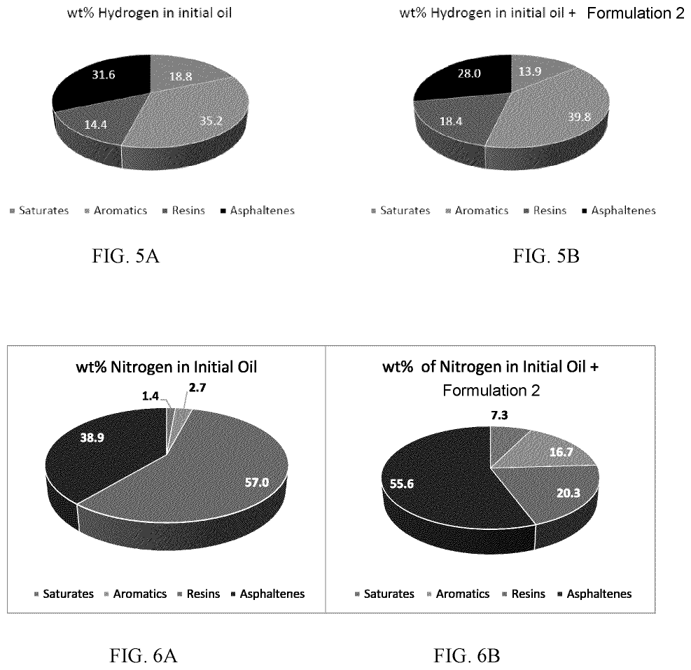

The compositional changes shown in FIG. 5 support these conclusions, and show the dehydrogenation (removal of hydrogen) from the Saturates and Asphaltenes fractions and the hydrogenation (increase in hydrogen) in the Aromatics and Resins fractions.

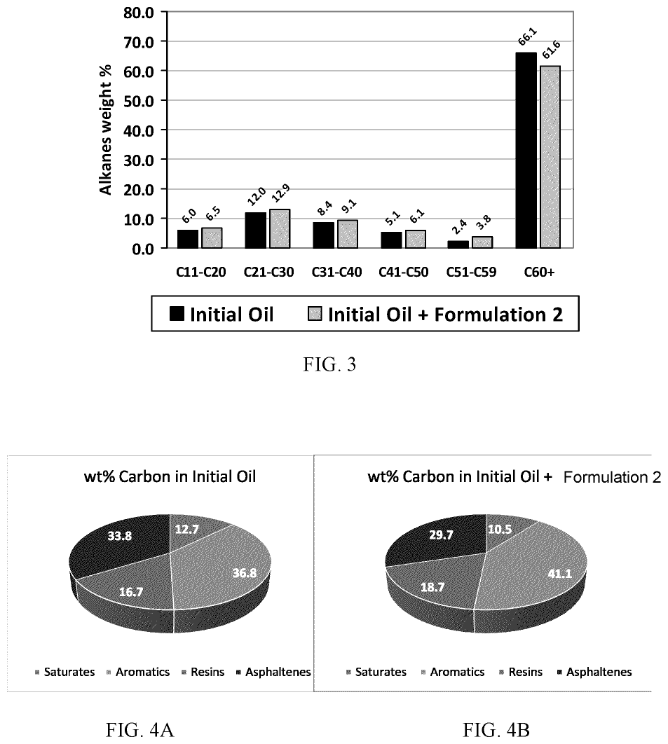

FIG. 3 shows that there were also some changes in the weight percentages of various types of alkanes in the oil. The changes shown are observed to comprise an increase in the lighter hydrocarbon components (C₁₁-C₅₉) and a reduction in heavier alkanes (C₆₀₊) after adding the formulation. This supports the finding that the addition of the formulation increases the lighter components of the saturated hydrocarbons and decreases the heavier component of the saturated fractions of crude oil.

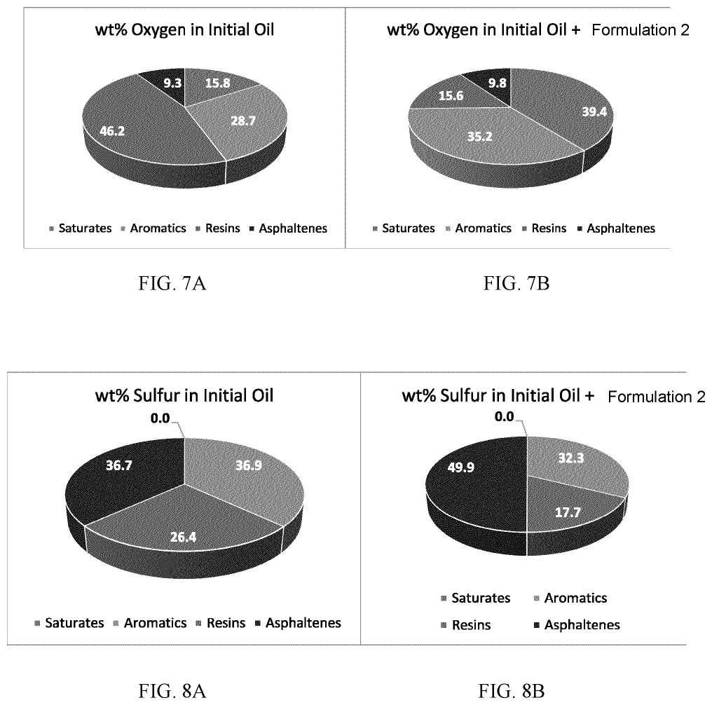

FIGS. 4A-8B show elemental analyses showing the distribution (content) of carbon (FIGS. 4A-4B), hydrogen (FIGS. 5A-5B) nitrogen (FIGS. 6A-6B), oxygen (FIGS. 7A-7B) and sulfur (FIGS. 8A-8B) through the SARA fractions.

After the addition of the formulation, the weight percentage of carbon in the Aromatics and Resins fractions increased, while the percentage in the Saturates and Asphaltenes decreased. In other words, the Asphaltenes fraction of the crude oil accumulates more non-carbon elements.

As noted above, any substance other than carbon or hydrogen in crude oil may be considered an impurity. In FIGS. 6A-6B, nitrogen distribution in the initial oil and in the oil/formulation blend is shown. Nitrogen content moves mainly from the Resins fraction to the Asphaltenes fraction after the addition of the formulation. Thus, de-asphalted oil (DAO) after addition of the formulation contains less nitrogen than the initial oil sample.

Oxygen is considered to be another impurity in crude oil. FIGS. 7A-7B show the oxygen distribution in the initial and oil/formulation blend. The Saturates and Aromatics fractions became more oxygenated after the addition of the formulation, while the weight percentages of oxygen in the Asphaltenes and Resins fractions decreased. This would have the effect of making these now oxygen-hungry frcations (Asphaltenes and Resins) more combustible: they are typically the most difficult fractions to combust.

As with oxygen and nitrogen, sulfur is also considered to be an impurity in crude oil. FIGS. 8A-8B give the sulfur distribution in crude oil before and after adding the formulation. While the sulfur content of the resins fraction decreases, the sulfur content of the asphaltenes fraction increases after the addition of the formulation.

The cations present in the crude oil were also analysed. These cations may be an integral part of the crude oil and are often called organo-metallic components. The following cations were analysed: Al, Ba, B, Cd, Ca, Cr, Cu, Fe, Pb, Li, Mg, Mn, Ni, P, K, Si, Na, Sr, and Zn.

As well as these organo-metallic compounds that are part of the crude oil molecule, it is important to point out that other cations (e.g. Na⁺) may have an inorganic origin (reservoir rock, reservoir waters-brines).

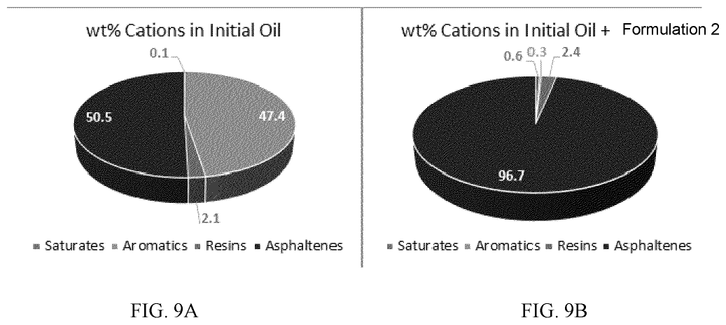

Both categories of cation are considered impurities. Their distribution is shown in FIGS. 9A-9B.

In the initial oil sample, most of these cations accumulated in the Asphaltenes and Aromatics fractions. After the addition of the formulation, most of the cations were found to have concentrated in just the Asphaltenes fraction.

From these results, it can be seen that the present formulations help to gather the majority of the impurities in just a single fraction of the crude oil (Asphaltenes). Accordingly, by removal of that fraction the result will be a ‘cleaner’ De-Asphalted Oil (DAO).

### Example 2

### Dehydrogenating Agent

As in Example 1, a crude oil sample taken from the Fort McMurray area of the Athabasca Region was mixed (blended) with a formulation as described above as Formulation 2.

The formulation was prepared by mixing the components of the formulation followed by leaving the mixture to stand for 72 hours. The formulation was blended with the crude oil sample at a ratio of 1:500.

Various comparisons of the chemical composition of the crude oil sample with and without the additive were performed.

As mentioned above, FIG. 1 shows the content of the SARA fractions in the crude oil with and without the formulation. FIG. 2 shows the H:C atomic ratio for the SARA fractions. FIG. 3 shows that there were also some small changes in the weight percentages of various types of alkanes in the oil. The small changes shown are observed to comprise an increase in the lighter hydrocarbon components (C₁₁-C₅₉) and a reduction in heavier alkanes (C₆₀₊) after adding the formulation. This supports the finding that the addition of the formulation increases the lighter components of the saturated hydrocarbons and decreases the heavier component of the saturated fractions of crude oil.

FIG. 2 demonstrates that there was a reduction of some 8.2% observed in the ratio of H:C atoms in the Saturates fraction after blending with the formulation. That is, in the Saturates fraction after blending with the formulation there is more unsaturation amongst the hydrocarbons present; i.e. there has been dehydrogenation.

FIG. 3 shows that, while the content proportion of C₆₀₊ alkanes wt % goes down after blending with the formulation, the content proportion of <C₆₀ alkanes wt % goes up. This indicates that the longer chain alkanes are being broken down into shorter chain alkanes. It is widely known that in such a ‘cracking’ reaction, two products are formed: the shorter chain alkane (CₙH₂ₙ₊₂) and an alkene (CₙH₂ₙ). This is an effective dehydrogenation, in that a dehydrogenated product (the alkene) is formed.

Similarly, FIGS. 4A-4B and 5A-5B demonstrate that the relative content of both carbon and hydrogen in the asphaltenes and saturates fractions reduce after addition of Formulation 2, increasing in the aromatics and resins fractions. This demonstrates that low molecular weight and unsaturated hydrocarbons are generated in the mixture from longer chain, saturated hydrocarbons. This is further evidence of what is shown by FIG. 3, effectively a ‘cracking’ reaction.

In FIGS. 5A-5B, for example, there was 25% less hydrogen in the Saturates fraction and 15% less hydrogen in the Asphaltene fraction after blending with the formulation, as a consequence of dehydrogenation (the direct removal of hydrogen from alkanes). In contrast, the Aromatics and Resins fractions showed 13% and 27% increases respectively in hydrogen, as a consequence of hydrogenation (the reverse of dehydrogenation), as hydrogen migrated to these fractions.

These Figures and the data therein therefore support the conclusion that the formulation has a dehydrogenating effect; it can be used as a dehydrogenating agent for hydrocarbons.

### Example 3

### EOR Fluid

The recovery performance of a Canadian Bitumen was tested through solvent and solvent-steam processes. The initial oil properties of the sample are listed in Table 1. The sample is classified as Bitumen even though it has an API gravity of 14.3° as its viscosity (˜51,000 cP) is more than 10,000 cP at reservoir temperature. Asphaltene content was measured according to ASTM D2007-11 (Standard method for SARA) by n-pentane washing. Hence, the asphaltenes mentioned are n-pentane insoluble asphaltenes. The asphaltene percentage for the sample was found to be 43.3%.

TABLE 1
Characteristics of Canadian Bitumen

| Property | Value |
|---|---|
| Colour | Black |
| Viscosity at 35° C., cP | 51395.5 |
| Density of Oil at Room Temperature, g/cm3 | 0.97032 |
| N-pentane insoluble asphaltene, wt. % | 43.3 |

Three core flooding experiments were conducted with two hydrocarbon solvents; the present Formulation 2 (explained above) and toluene. Experimental conditions are mentioned in Table 2.

TABLE 2
Coreflooding experimental conditions

| Property | Value |
|---|---|
| Back Pressure, psi | 75 |
| Temperature, ° C. | ~20 |
| Solvent Injection rate, ml/min | 2 |
| Steam Injection rate, ml/min | 18 |
| Core cell volume, cc | 451 |

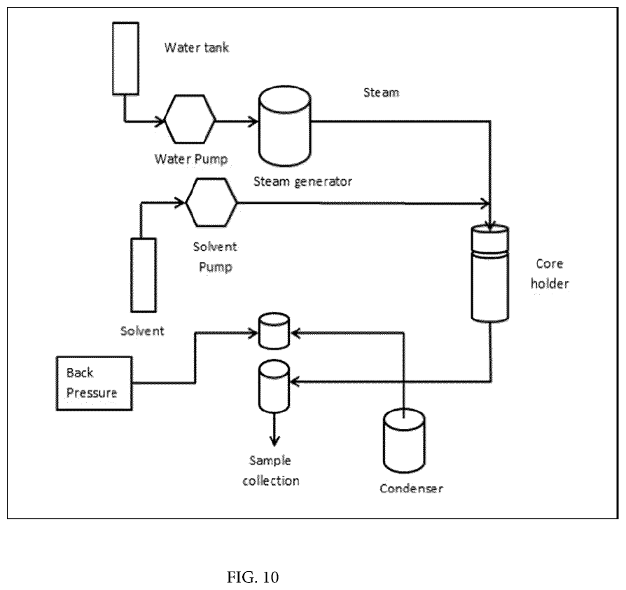

The core pack was prepared by blending Ottawa sand with 40% pore volume (PV) of water and 60% PV of oil. The sand grains were first mixed with water in a mixing bowl to coat the grains with a water film to maintain water wetness. Then, the oil was added to the mixture. This mixture was packed to a core holder with 2.13 in (5.41 cm) inner diameter and 7.84 in (20 cm) length. After the core holder was sealed, it was placed into the experimental setup shown schematically in FIG. 10.

As shown FIG. 10, the bottom end of the core holder is connected via production tubing to a back pressure regulator and separator. Back pressure was kept at 75 psi through nitrogen injection. Production samples were collected every 20 minutes from the outlet of the separator. A solvent pump was used to pump the solvents (either Formulation 2 or Toluene) into the core holder at 2 mL/min rate at 20° C. A water pump first pumped water into a steam generator, and generated steam was injected to core holder at 18 ml/min cold water equivalent rate at 250° C.

Three coreflood experiments were conducted at the same experimental conditions by just changing the injected EOR (Enhanced Oil Recovery) fluid type. In the first experiment; E1, Steam was injected alone at 18 mL/min rate; thus, this experiment represents a steam flooding process of the prior art. In the second experiment; E2, Formulation 2 was injected alone at 2 mL/min rate; thus this experiment represents an embodiment of the disclosure. In the third experiment; E3, toluene was injected alone at 2 mL/min rate; thus, this experiment represents an embodiment of a known hydrocarbon EOR fluid. E2 and E3 are miscible flooding processes.

After each experiment, the produced liquids collected during each experiment were visualized under optical microscopy to observe the presence of water-in-oil emulsions in the produced liquids.

Mass of all packed (oil, water, and sand), injected (solvent and water), and produced (oil, water, and gas) components were measured. Through mass balance calculations, the amount of residual oil was determined.

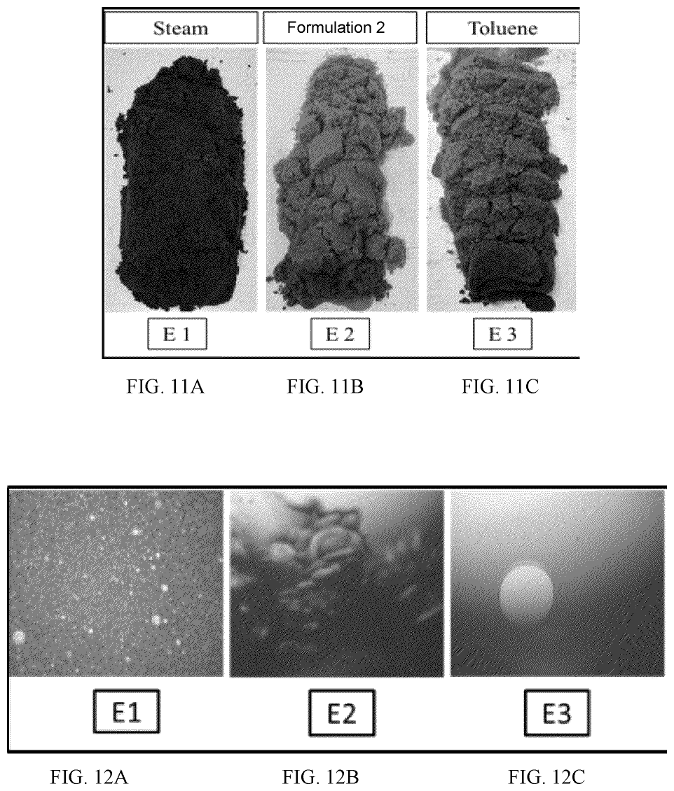

The spent rock images from all experiments are provided in FIGS. 11A-11C.

As evident in FIGS. 11A-11C, the sole injection of Formulation 2 (E2) resulted in the lightest colour implying the highest oil recovery.

The residual oil, the displacement efficiency (volume percent of the whole core), and total experiment time parameters are provided in Table 3. Note that the initial oil saturation was 60 vol. %.

While E2 and E3 provide very similar sweep efficiencies, E2 was conducted in a shorter period of time. Hence, Formulation 2 had fewer pore volumes (PVs) injection than toluene to recover the same amount of oil.

TABLE 3
Post mortem results for core flooding experiments.
Initial oil vol % was 60 vol % of the core pack.

| | | Residual Oil | Displacement | Experiment |
|---|---|---|---|---|
| Experiment | Solvent | Saturation, | efficiency, | run time, |
| number | Injected | vol % | vol. % | min |
| E1 | Steam | 49.6 | 17.4 | 196 |
| E2 | Formulation 2 | 42.7 | 28.9 | 93 |
| E3 | Toluene | 42.8 | 28.7 | 143 |

Emulsion characterization was conducted on produced oil samples taken every 20 minutes from each of the core flooding experiments. An image from each of the three experiments on Canadian Bitumen is depicted in FIGS. 12A-12C. The resulting image for Canadian Bitumen show experiment E1 (Steam) contains higher water content i.e., stronger emulsion formations indicating lower oil quality due to higher asphaltene content. This sample will require more processing effort to separate oil from the emulsion.

Emulsion stability is dependent on the existence of polar components and their interactions with emulsion. In this case, the main polar components are water, asphaltenes, and resins. Consequently, stronger emulsion formations are indicative of higher asphaltene content. Experiments involving steam are expected to form stronger emulsions as steam promotes more severe emulsion formations than liquid water. Additionally, as the stability of emulsion increases, separating oil from the emulsion (emulsion breaking) becomes more difficult and consumes more energy. Thus, stronger emulsions indicate lower oil quality and result in lower oil recovery. The smaller average size of emulsion droplets results in longer residence time. This implies a larger separation setup. Thus, from FIGS. 12A-12C, it is evident that the lowest oil quality was achieved by sole steam injection (E1). On the other hand, images of samples from E2 (Formulation 2) showed very little to no water content. Hence, produced oil quality was best with Formulation 2.

To check for economic viability, three parameters were evaluated; oil recovery in terms of bbl./acre.ft, the number of pore volumes injected, and the cost of solvent. Cost calculations were determined by taking the cost of toluene and Formulation 2 as 0.055 and 0.057 $/ml. The price of steam in these calculations is omitted as it is almost purely dependent on energy cost and hence almost impossible to standardise for comparison. These prices were obtained from costs provided by commercial vendors of chemicals as of March 2021. The results are summarized in Table 4.

Table 4 shows that the cost of Formulation 2 injection is higher than that of toluene. However, as the amount of pore volume required is almost half of that of toluene, it is still a viable option. Overall, considering oil quality, recovery, PVs required and cost of solvent, Formulation 2 is the best recovery method assessed. This recovery method also reduces environmental damage by reducing the amount of toxic solvent injected into the reservoir.

TABLE 4
Economic parameters for Canadian Bitumen

| Experiment | Solvent | Oil recovery, | Cost of | |
|---|---|---|---|---|
| number | Injected | bbl./acre. ft | solvent, $ | PVs injected |
| E1 | Steam | 454 | 0 | — |
| E2 | Formulation 2 | 752 | 0.9 | 1.1 |
| E3 | Toluene | 747 | 0.6 | 1.6 |

In summary:
1. Experiments involving steam are more likely to have stronger emulsion formations, making it difficult for processing and separation. Stronger emulsion stability is also indicative of higher asphaltene precipitation and consequently lower oil quality.
2. Formulation 2 performed the best, resulting in the highest oil recovery. Formulation 2 also produced better quality oil and required lower pore volumes.
3. Formulation 2 can be used in smaller volumes than conventional toxic aromatic solvents like toluene for heavy oil recovery. Hence, if oil recovery efficiencies of Formulation 2 are comparable to conventional aromatic solvents, it can reduce the environmental damage caused by these toxic chemicals.

### Example 4

### EOR Fluid

Experiments were conducted in the same way as in Example 3, E2, using different oils in place of the Canadian Bitumen used in Example 3.

The first tested oil was a Fort McMurray Athabasca sample; it was found that the addition of Formulation 2 increased the recovery of oil from the oil sand sample by approximately 33%, again outperforming the use of toluene. The oil had the following properties:

TABLE 5

| | | | Elemental Composition | | | | | |
|---|---|---|---|---|---|---|---|---|
| AP | Viscosity at | n-pentane insoluble | C, | H, | S, | Ni, | V, | Na, |
| Gravity | 21° C., cP | asphaltenes, wt % | wt % | wt % | ppm | ppm | ppm | ppm |
| 6.11 | 1,979,082 | 40.08 | 81.2 | 10.4 | 58200 | 9.76 | 258 | 504 |

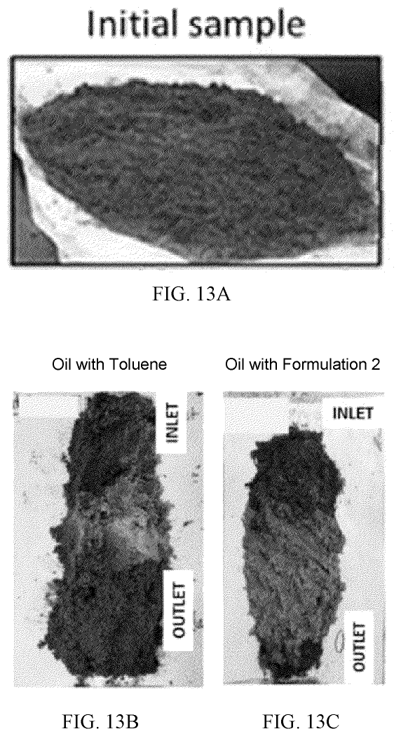

Images of the sample, initially and after ‘extraction’ using toluene and Formulation 2, are shown in FIGS. 13A-13C.

The second tested oil was an Athabasca crude. With this oil, an approximately 50% increase in oil recovery was observed.

### Example 5

### Viscosity Reducer

Formulation of the above types Formulations 3, 4 and 5 were mixed with a series of different oils and oily liquids.

In each case, the formulation was prepared and allowed to remain at room temperature for at least 72 hours. Then, it was mixed with the relevant oil sample in an amount of 1 ml per 1000 ml of each oil. The viscosities of the blends were measured using a Brookfield DV III Ultra Rheometer at various different temperatures, including 30° C., 40° C., 50°° C. and 60° C.

The oil samples themselves were taken from wells in Texas, Alaska, and Canada.

TABLE 6

| | | API | Viscosity |
|---|---|---|---|
| Oil Type | Oil Origin/category | Gravity | at 21° C., cP |
| Oil A | Canadian Bitumen | 8.19 | 53200 |
| Oil B | Texas Heavy Crude | 17.12 | 607 |
| Oil C | Canadian Athabasca Bitumen | 6.11 | 1,979,082 |
| Oil D | Alaska North Slope Heavy | 18.84 | 884 |
| | Crude | | |

Tests of Formulation 3 as a treatment of Oils B, C and D gave the following results:

TABLE 7

Viscosity, cP

| | | 30° C. | 40° C. | 50° C. | 60° C. |
|---|---|---|---|---|---|
| Oil B | Initial | 266 | 137 | 82 | 53 |
| | Treated | 15 | 6 | 3 | 2 |
| Oil C | Initial | 1812948 | 271903 | 62416 | 18754 |
| | Treated | 970 | 404 | 205 | 118 |
| Oil D | Initial | 525 | 215 | 108 | 61 |
| | Treated | 145 | 91 | 64 | 47 |

Tests of Formulation 4 as a treatment of Oils A, B and C gave the following results:

TABLE 8

Viscosity, cP

| | | 30° C. | 40° C. | 50° C. | 60° C. |
|---|---|---|---|---|---|
| Oil A | Initial | 18242 | 5626 | 2259 | 1072 |
| | Treated | 13396 | 4268 | 1757 | 851 |
| Oil B | Initial | 266 | 137 | 82 | 53 |
| | Treated | 83 | 31 | 15 | 8 |
| Oil C | Initial | 1812948 | 271903 | 62416 | 18754 |
| | Treated | 654 | 320 | 184 | 117 |

Tests of Formulation 5 as a treatment of Oils B, C and D gave the following results:

TABLE 9

Viscosity, cP

| | | 30° C. | 40° C. | 50° C. | 60° C. |
|---|---|---|---|---|---|
| Oil B | Initial | 266 | 137 | 82 | 53 |
| | Treated | 12 | 5 | 2 | 1 |
| Oil C | Initial | 1812948 | 271903 | 62416 | 18754 |
| | Treated | 909 | 377 | 191 | 109 |
| Oil D | Initial | 525 | 215 | 108 | 61 |
| | Treated | 235 | 124 | 76 | 50 |

The remarkable reductions in viscosity provided by the present formulations can clearly be seen in these results.

1-11. (canceled)

12. Use of a formulation, comprising:
(a) from about 5 to about 25 weight percent naphthalene;
(b) from about 75 to about 95 weight percent of a component which is either (b2) a mixture of aromatic hydrocarbon and methanol or ethanol; or (b3) methanol or ethanol;
and
(c) from about 0.8 to about 4 weight percent benzyl alcohol;
as a viscosity reducing agent.

13. The use according to claim 12, wherein the formulation is used in a method of reducing the viscosity of a hydrocarbon based fluid.

14. The use according to claim 13, wherein the method comprises blending the formulation with the hydrocarbon based fluid.

15. Use of a formulation, comprising:
(a) from about 5 to about 25 weight percent naphthalene;
(b) from about 75 to about 95 weight percent of a component which is either (b1) aromatic hydrocarbon; or (b2) a mixture of aromatic hydrocarbon and methanol or ethanol; or (b3) methanol or ethanol;
and
(c) from about 0.8 to about 4 weight percent benzyl alcohol;
in a method of extracting crude oil from a porous medium.

16. The use according to claim 15, wherein the method comprises introducing the formulation down an injection well into the porous medium containing the crude oil; and
then extracting crude oil from the porous medium.

17. A formulation, comprising:
(a) from about 5 to about 25 weight percent naphthalene;
(b) from about 75 to about 95 weight percent of a component which is either (b2) a mixture of aromatic hydrocarbon and methanol or ethanol; or (b3) methanol or ethanol;
and
(c) from about 0.8 to about 4 weight percent benzyl alcohol.
